(19) United States
(12) Patent Application Publication
(10) Pub. No.: US 2006/0006849 A1
(43) Pub. Date: Jan. 12, 2006

(54) Inductor compensating circuit

(76) Inventors: James William Haslett, Calgary (CA); Christopher Daniel Holdenried, Toronto (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/170,719

(22) Filed: Jun. 28, 2005

Related U.S. Application Data
(60) Provisional application No. 60/582,826, filed on Jun. 28, 2004.

(51) Int. Cl. G05F 1/12

(52) U.S. Cl. 323/247

(57) ABSTRACT

An inductor compensating circuit, comprising a first inductor, a second inductor, and a third inductor. A source of voltage applies an AC voltage to the first inductor. Two transistors are connected as a differential pair. A current source is connected to the source of the transistors, and the first inductor is connected between the gates of the differential pair such that the current of the differential pair is proportional to the AC voltage in the first inductor and that has a phase relationship with the AC voltage in the first inductor to achieve loss compensation in the first inductor. The second and third inductors are driven by the differential pair and coupled to the first inductor to compensate for loss in the first inductor.

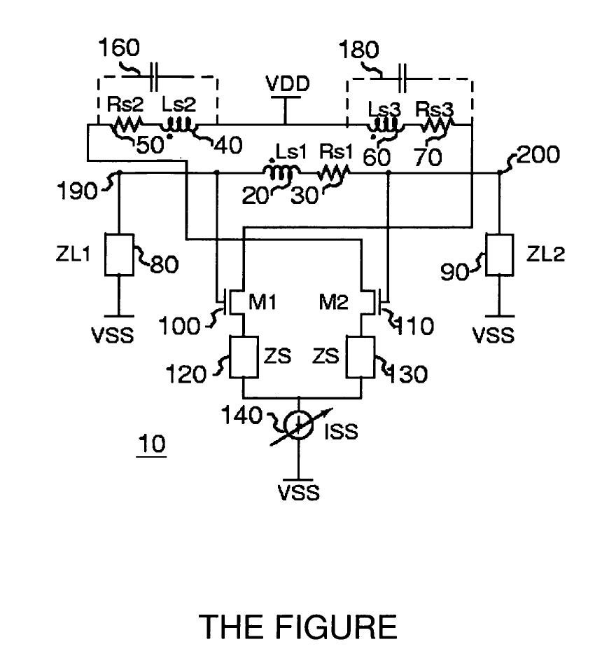

### BACKGROUND OF THE INVENTION

In integrated circuits, on-chip spiral inductors are typically poor because they have a low quality (O) factor. Some of the inventors of this patent have previously disclosed some ideas for compensating the loss of an inductor in the article “Tunable Coupled Inductor Q-Enhancement for Parallel Resonant LC Tanks”, Bogdan Georgescu et al, IEEE Transactions on Circuits and Systems II: Analog and Digital Signal Processing, Vol. 50, No. 10, October 2003, pp. 705-713, and in U.S. Pat. No. 6,822,434. The novel circuit ideas disclosed here expand upon the ideas in that work by eliminating the requirement that one end of the inductor be connected to a signal ground.

### SUMMARY OF THE INVENTION

According to an aspect of the invention, there is provided an inductor compensating circuit, comprising a first inductor, a source of voltage to apply an AC voltage to the first inductor, transistors connected as a differential pair and having a source, a current source connected to the source of the transistors, a second inductor driven by the differential pair and coupled to the first inductor; and the first inductor connected between the gates of the differential pair such that the current of the differential pair is proportional to the AC voltage in the first inductor and has a phase relationship with the AC voltage in the first inductor to achieve loss compensation in the first inductor. There may also be a third inductor driven by the differential pair and coupled to the first inductor and the second inductor to compensate for loss in the first inductor. If a first inductor and second inductor are present, they may comprise the windings of a transformer. If a first inductor, second inductor and third inductor are present, they may comprise the windings of a balun. The first inductor may be a component in a circuit selected from the group consisting of a filter, an LC pseudo transmission line, a resonator, and an oscillator, and the transistors may be selected from a group consisting of: field effect transistors, bipolar junction transistors, heterojunction bipolar transistors.

According to further aspects of the invention, the current source may be a variable current source and may be varied by an external circuit adapted to optimize the loss compensation. The inductor compensating circuit may comprise a circuit stabilizing element connected to the differential pair. There may be more than one differential pair connected in parallel, where each differential pair is biased by a different bias current and each differential pair has different sized transistors.

According to a further aspect of the invention, there is provided a method of using the same.

Other aspects of the invention will be apparent from a reading of the description and the claims, which are incorporated herein by reference.

### BRIEF DESCRIPTION OF THE DRAWINGS

There will now be described preferred embodiments of the invention, for the purpose of illustration only, by reference to the sole figure, which is a schematic view of an inductor compensating circuit according to a preferred embodiment of the invention.

### DETAILED DESCRIPTION OF PREFERRED EMBODIMENTS

In the claims, the word “comprising” is used in its inclusive sense and does not exclude other elements being present.

The figure shows a way of compensating for the loss through a first inductor by using multiple other inductors that are coupled to the first inductor. To achieve this, currents are drawn through the multiple other inductors that are proportional to the voltage across the first inductor, and that have a phase relationship with the AC voltage in the first inductor to achieve loss compensation. As an example, to achieve loss compensation in a transformer having a voltage across the primary winding, the current through the secondary winding may be proportional to, and in phase with, the voltage in the primary winding.

Inductor compensating circuit 10 in the figure shows a first inductor 20 coupled to two other inductors 40 and 60. The coupling is represented by the dots by each inductor. The resistive loss of each of these inductors is shown explicitly by resistors 30, 50, and 70 respectively. The three inductors in circuit 10 are all coupled to one another. Inductor 20 is the inductor whose resistive loss 30 is to be compensated and inductor 20 may be connected as part of a filter, an LC pseudo transmission line, a resonator, an oscillator, and any other circuit where an inductor is needed. For example, when used in a parallel resonator, a capacitor (not shown) would be connected from point 190 to point 200. In order to illustrate that inductor 20 can be connected to a variety of circuits, it is shown terminated by the complex impedances 80 and 90 labeled ZL1 and ZL2 respectively. In this patent document, we will refer to these circuits applying a voltage to inductor 20. However, those skilled in the art will recognize that the circuits could also drive a current through inductor 20, and the invention contemplates those situations as well. These impedances may take on values with a magnitude from zero to infinity. It can be shown that the impedance between points 190 and 200 may be made equal to the impedance corresponding exactly to the inductance 20 at a given frequency, assuming ideal transistors 100 and 110 labeled as M1 and M2. In practice, these transistors will have parasitic capacitance associated with them and the inductors will have a coupling factor less than unity. However, the impedance between points 190 and 200 may still be made equal to the impedance corresponding to the inductance 20 at a given frequency. Furthermore, although M1 and M2 are shown as MOS transistors, circuit 10 will operate equally well when bipolar, heterojunction, or other types of transistors are used.

Since inductors 20, 40, and 60 are all coupled to each other, these three inductors may be implemented on an integrated circuit using a spiral balun. In some high frequency applications, on-chip baluns may be difficult to design. Hence, it may be sometimes desirable to eliminate one of inductor 40 or inductor 60, so that only one inductor is coupled to the primary inductor 20. If, for example, inductor 40 were removed, then its inherent loss resistance 50 would also be removed, and the drain of transistor M2 would connect directly to VDD. Then, the remaining two inductors 20 and 60 could be implemented on an integrated circuit using a spiral transformer, which is easier to design at high frequencies than a spiral balun. There are certain advantages to using a balun so that there are two other inductors coupled to the primary inductor, namely lower power requirements and potentially lower noise. However, even if one of inductor 40 or 60 is removed, the impedance between points 190 and 200 may still be made substantially equal to the impedance corresponding to the inductance 20 at a given frequency.

In U.S. Pat. No. 6,822,434, incorporated herein by reference, there is a description of how the impedance of a coupled inductor circuit may become unstable, meaning that the real part of the complex impedance may become negative. In a similar way, the impedances at nodes 190 and 200 may become unstable. One way to avoid instability in circuit 10 is to include optional capacitors 160 and 180. These capacitors reduce the loss compensation of inductor 20 at high frequencies. Another way to avoid instability is through the use of the complex degeneration impedances 120 and 130. These impedances could each be an inductor and a capacitor in parallel which are chosen to resonate at the frequency where instability is to be avoided. The effect of impedances 120 and 130 is to reduce the loss compensation at desired frequencies.

In circuit 10, transistors M1 and M2 form a source coupled differential pair. This pair is biased by the variable current source 140. It will be understood that current source 140 may take various forms. For example, it may be a variable voltage resistor connected to provide a current through the differential pair, or any other suitable current source. If a very high voltage signal is applied between nodes 190 and 200, all of the current ISS may be steered to either M1 or M2, and circuit 10 will then fail to compensate the resistive loss 30 of inductor 20. The maximum voltage that can be applied between nodes 190 and 200 where circuit 10 still compensates the resistive loss 30 of inductor 20 is related to the 1 dB compression point of the circuit. The 1 dB compression point of the circuit may be raised using standard techniques which fall under the heading of translinear circuit design, and which involves replacing the single source coupled differential pair connected to points 190 and 200 with several source coupled differential pairs in parallel. By having multiple source coupled differential pairs in parallel, each pair with a different bias current and with different size transistors, it is possible to raise the 1 dB compression point of circuit 10.

Finally, in some applications, it may be desirable to place circuit 10 in a larger circuit that provides a means of automatically tuning the current source 140 to provide a desired amount of loss compensation. An external circuit may be provided which periodically evaluates the impedance, current, voltage, or noise at nodes 190 and 200 and which tunes ISS until a combination of these parameters reaches a desired value.

Immaterial modifications may be made to the circuit described here without departing from the invention.

We claim:

1. An inductor compensating circuit, comprising:
a first inductor;
a source of voltage to apply an AC voltage to the first inductor;
transistors connected as a differential pair and having a source;
a current source connected to the source of the transistors;
a second inductor driven by the differential pair and coupled to the first inductor; and
the first inductor connected between the gates of the differential pair such that the current of the differential pair is proportional to the AC voltage in the first inductor and has a phase relationship with the AC voltage in the first inductor to achieve loss compensation in the first inductor.

2. The inductor compensating circuit of claim 1 further comprising a third inductor driven by the differential pair and coupled to the first inductor and the second inductor to compensate for loss in the first inductor.

3. The inductor compensating circuit of claim 1 wherein the current source connected to the source of the transistors is a variable current source.

4. The inductor compensating circuit of claim 3 wherein the variable current source is varied by an external circuit adapted to optimize the loss compensation.

5. The inductor compensating circuit of claim 1, wherein the first inductor is a component in a circuit selected from the group consisting of: a filter, an LC pseudo transmission line, a resonator, and an oscillator.

6. The inductor compensating circuit of claim 1, wherein the transistors are selected from a group consisting of: field effect transistors, bipolar junction transistors, and heterojunction bipolar transistors.

7. The inductor compensating circuit of claim 2, wherein the first inductor, the second inductor and the third inductor comprise the windings of a balun.

8. The inductor compensating circuit of claim 1, wherein the circuit further comprises a circuit stabilizing element connected to the differential pair.

9. The inductor compensating circuit of claim 8, wherein the circuit stabilizing element comprises a capacitor connected across the second inductor.

10. The inductor compensating circuit of claim 1, wherein the differential pair comprises more than one differential pair connected in parallel, where each differential pair is biased by a different bias current and each differential pair has different sized transistors.

11. A method of compensating an inductor in a circuit, the method comprising the steps of:
providing two transistors connected as a differential pair;
connecting a first inductor to be compensated between the gates of the differential pair;
connecting a second inductor and a third inductor to the differential pair and coupling the second inductor and the third inductor to the first inductor; and
driving the differential pair with a current that is proportional to the AC voltage in the first inductor and that has a phase relationship with the AC voltage in the first inductor to achieve loss compensation in the first inductor.

12. A transformer compensated circuit, comprising:
a transformer having a primary winding and a secondary winding;
a source of voltage connected to apply an AC voltage to the primary winding of the transformer;
a current source connected to drive AC current into the secondary winding of the transformer;
the current source being configured to drive an AC current into the secondary winding that is proportional to the AC voltage in the primary winding and that has a phase relationship with the AC voltage in the primary winding to achieve loss compensation in the primary winding; and
a circuit stabilizing element connected to the secondary winding.

13. The transformer compensated circuit of claim 12, wherein the circuit stabilizing element comprises a capacitor connected across the secondary winding.
